(19) United States
(12) Patent Application Publication
(10) Pub. No.: US 2014/0222316 A1
(43) Pub. Date: Aug. 7, 2014

(54) CONTROL APPARATUS AND CONTROL METHOD FOR INTERNAL COMBUSTION ENGINE

(71) Applicant: HITACHI AUTOMOTIVE SYSTEMS, LTD., Hitachinaka-shi (JP)

(72) Inventor: Atsushi MURAI, Isesaki-shi (JP)

(73) Assignee: HITACHI AUTOMOTIVE SYSTEMS, LTD., Hitachinaka-shi (JP)

(21) Appl. No.: 14/025,436

(22) Filed: Sep. 12, 2013

(30) Foreign Application Priority Data
Feb. 7, 2013 (JP) 2013-022013

(51) Int. Cl. F02D 35/02

(52) U.S. Cl. CPC F02D 35/026
USPC 701/104; 701/113; 374/144

(57) ABSTRACT

A control apparatus and a control method for an internal combustion engine in a vehicle in which a battery and the internal combustion engine are mounted estimate a temperature of the internal combustion engine based on battery voltage. The control apparatus estimates water temperature TWS, at the time of starting up the internal combustion engine, based on battery voltage VB before starting the startup of the internal combustion engine or minimum value VBmin of battery voltage VB during cranking. Then, the control apparatus controls a fuel injection amount and a valve timing based on water temperature TWS estimated based on battery voltage VB when a water temperature sensor has failed.

### BACKGROUND OF THE INVENTION

1. Field of the Invention

The present invention relates to a control apparatus and to a control method for an internal combustion engine provided in a vehicle in which a battery and the internal combustion engine are mounted.

2. Description of Related Art

Japanese Laid-open Patent Application Publication No. H01-100346 discloses that when an internal combustion engine is started up in a condition in which a temperature sensor that measures a temperature of the internal combustion engine (for example, a temperature of cooling water) has failed, the internal combustion engine is controlled assuming that the temperature of the internal combustion engine is a predetermined temperature.

However, in the case in which the temperature sensor has failed, if correction of a fuel injection amount, or the like, is performed based on the predetermined temperature, the fuel injection amount might be inappropriate due to a difference between an actual temperature and the predetermined temperature, and accordingly, the startup performance might be degraded.

Furthermore, in the case in which a measurement error increases due to degradation of the temperature sensor, the startup performance might be degraded, similarly to the case in which the temperature sensor has failed.

If the temperature of the internal combustion engine at the time of starting up the internal combustion engine can be estimated, it is possible to maintain a good startup performance without using the temperature sensor. In addition, estimation of degradation state of the temperature sensor, and the like, can be performed by comparing a measured value obtained from the temperature sensor with the estimated value.

### SUMMARY OF THE INVENTION

It is therefore an object of the present invention to provide a means for estimating a temperature of an internal combustion engine at the time of starting up the internal combustion engine.

In order to achieve the above object, according to an aspect of the present invention, a control apparatus for an internal combustion engine provided in a vehicle in which a battery and the internal combustion engine are mounted, includes a temperature estimating unit that estimates a temperature of the internal combustion engine at the time of starting up the internal combustion engine based on a voltage of the battery.

Furthermore, according to another aspect of the present invention, a control method for an internal combustion engine provided in a vehicle in which a battery and the internal combustion engine are mounted, includes the steps of: measuring a voltage of the battery at the time of starting up the internal combustion engine; estimating a temperature of the internal combustion engine based on the voltage of the battery; and controlling the internal combustion engine based on the temperature of the internal combustion engine.

Other objects and features of aspects of the present invention will be understood from the following description with reference to the accompanying drawings.

### BRIEF DESCRIPTION OF THE DRAWINGS

FIG. 1 is a system diagram of an internal combustion engine according to an embodiment of the present invention;

FIG. 2 is a flowchart illustrating a process for estimating a water temperature TWS according to an embodiment of the present invention;

FIG. 3 is a diagram illustrating a correlation between a battery voltage VB and a water temperature TWS according to an embodiment of the present invention;

FIG. 4 is a timing diagram illustrating the relationships among an ignition switch, a start switch, a battery voltage, and an engine rotation speed according to an embodiment of the present invention;

FIG. 5 is a flowchart illustrating a computing process of a fuel injection amount according to an embodiment of the present invention;

FIG. 6 is a diagram illustrating a correlation between a water temperature TWS and a fuel injection amount according to an embodiment of the present invention;

FIG. 7 is a flowchart illustrating a computing process of a fuel injection amount according to an embodiment of the present invention;

FIGS. 8A and 8B are diagrams, each of which illustrates a correlation between a water temperature TWS and a valve timing according to an embodiment of the invention;

FIG. 9 is a flowchart illustrating a controlling process of a valve timing according to an embodiment of the present invention;

FIG. 10 is a diagram illustrating a correlation between a water temperature TINS and a delay time TD according to an embodiment of the present invention;

FIG. 11 is a timing diagram illustrating the relationships among an ignition switch, a start switch, a battery voltage, an engine rotation speed, and a valve timing according to an embodiment of the present invention;

FIG. 12 is a timing diagram illustrating the relationships among an ignition switch, a start switch, a battery voltage, an engine rotation speed, and a valve timing according to an embodiment of the present invention;

FIG. 13 is a flowchart illustrating a estimating process of a water temperature TWS according to an embodiment of the present invention;

FIG. 14 is a timing diagram illustrating the relationships among an ignition switch, a start switch, a battery voltage, and an engine rotation speed according to an embodiment of the present invention;

FIG. 15 is a diagram illustrating a correlation between a minimum voltage VBmin and a water temperature TWS according to an embodiment of the present invention;

FIG. 16 is a flowchart illustrating a estimating process of a water temperature TWS according to an embodiment of the present invention; and

FIG. 17 is a diagram illustrating a correlation among a state of charge SOC, an open-circuit voltage and a battery temperature according to an embodiment of the present invention.

### DESCRIPTION OF THE PREFERRED EMBODIMENTS

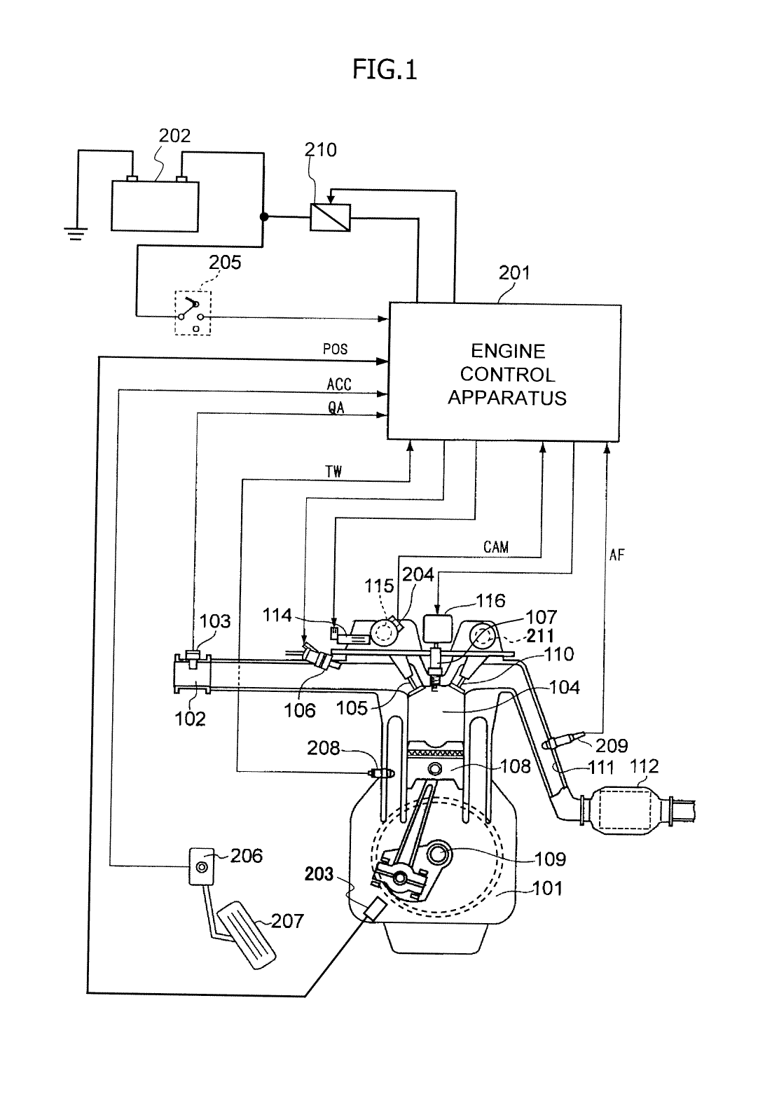

FIG. 1 is a diagram illustrating one example of a vehicle engine to which a control apparatus according to an embodiment of the invention is applied.

An engine 101 illustrated in FIG. 1 is an internal combustion engine, and in an intake pipe 102 for introducing air into each cylinder of engine 101, disposed is an intake air amount sensor 103 that measures an intake air flow amount QA of engine 101.

Intake valves 105 open and close intake ports of a combustion chamber 104 in each cylinder.

In intake pipe 102 at the upstream side of intake valve 105, a fuel injection valve 106 is provided in each cylinder.

An in-cylinder direct injection type fuel injection device in which fuel injection valve 106 directly injects fuel into combustion chamber 104 may be provided.

The fuel injected from fuel injection valve 106 is drawn into combustion chamber 104 together with air via intake valve 105, and is ignited and combusted by a spark ignition using a spark plug 107. Then, a pressure caused by the combustion of the fuel forces a piston 108 downward toward a crank shaft 109 to drive crank shaft 109 to rotate.

Furthermore, exhaust valves 110 open and close exhaust ports of combustion chamber 104. By opening exhaust valve 110, exhaust gas is discharged into an exhaust pipe 111.

In exhaust pipe 111, a catalytic converter 112 equipped with a three-way catalyst, or the like is disposed. Catalytic converter 112 purifies exhaust gas.

Intake valve 105 and exhaust valve 110 which have functions as engine valves are opened along with rotation of an intake camshaft 115 and an exhaust camshaft 211 driven to rotate through crank shaft 109.

While exhaust valve 110 opens at certain valve timing, valve timing of intake valve 105 is made variable by a variable valve timing mechanism 114.

As variable valve timing mechanism 114, an electric-drive variable valve timing mechanism is employed in the present embodiment.

Electric-drive variable valve timing mechanism 114 is, for example, a mechanism in which a rotation force of a rotor of an electric motor is transmitted to a camshaft while the rotation force is reduced by a reduction mechanism, and a relative rotation phase of the camshaft with respect to crank shaft 109 is continuously varied, so that an opening and closing timing of the engine valve is made variable. One example is a mechanism having a configuration as disclosed in Japanese Laid-open Patent Application Publication No. 2011-256798.

On spark plug 107, an ignition module 116 that supplies ignition energy to spark plug 107 is directly mounted. Ignition module 116 is provided with a spark coil and a power transistor that controls application of current to the spark coil.

A control apparatus 201 is provided with a computer, thereby receiving signals input from various sensors and switches to perform computing processing in accordance with a pre-stored program, and thereby computing to output manipulated variables of various devices, such as fuel injection valve 106, variable valve timing mechanism 114, ignition module 116, and the like, to thereby control an operation of engine 101.

Control apparatus 201 receives not only an signal output from intake air amount sensor 103, but also signals output from a crank angle sensor 203 that outputs a rotational angle signal POS of crank shaft 109, an accelerator opening sensor 206 that measures accelerator opening ACC of a throttle pedal 207, a cam angle sensor 204 that outputs a rotational angle signal CAM of intake camshaft 115, a water temperature sensor 208 that measures a temperature TW of cooling water of engine 101, an air-fuel ratio sensor 209 that is disposed in exhaust pipe 111 at the upstream side of catalytic converter 112 and measures an air-fuel ratio AF based on oxygen level in exhaust gas, and the like.

In the present embodiment of the present invention, water temperature TW is a temperature of cooling water measured by water temperature sensor 208, and a water temperature TWS is a temperature of cooling water estimated based on a battery voltage VB, as described below.

In a vehicle in which engine 101 is mounted, a battery 202 is provided.

Then, control apparatus 201 is supplied with electric power from battery 202 via an ignition switch 205, which is a main switch for starting and stopping engine 101. In addition, control apparatus 201 has a function for measuring a voltage VB of battery 202.

Furthermore, control apparatus 201 may be supplied with electric power from battery 202 via a relay 210 for performing self-shutoff. After ignition switch 205 is turned off, control apparatus 201 executes self-shutoff by turning off relay 210.

Here, control apparatus 201 has a function, as software, for estimating a temperature of engine 101 based on battery voltage VB when engine 101 is started up.

As described above, estimating the temperature of engine 101 based on a correlation between the temperature of engine 101 and battery voltage VB, allows the engine temperature estimated based on battery voltage VB to be used instead of a measurement result obtained from the temperature sensor 208. Therefore, the temperature sensor may be omitted, and accordingly, costs could be reduced. Furthermore, control processing in accordance with the engine temperature can be continued even when the temperature sensor 208 has failed. Still further, by comparing the measurement result obtained from the temperature sensor 208 with the engine temperature estimated based on battery voltage VB, a state of degradation of the temperature sensor 208 can be diagnosed.

Hereunder, a process of estimating the engine temperature based on battery voltage VB will be described in detail.

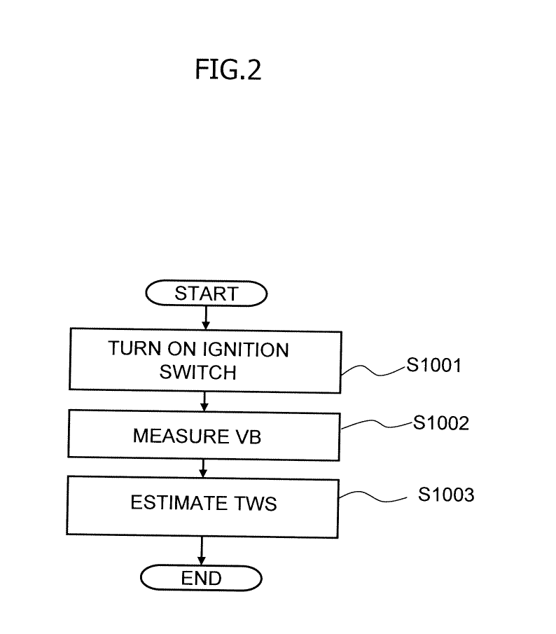

A flowchart of FIG. 2 illustrates one example of the temperature estimating process.

In the temperature estimating process illustrated in the flowchart of FIG. 2, temperature TWS of cooling water of engine 101 at the time of starting up engine 101 is estimated based on battery voltage VB.

Since there is a correlation between battery voltage VB and a temperature of engine 101, and since discharge capacity of battery 202 varies according to temperature of battery 202, so that battery voltage VB varies, a temperature of engine 101 can be estimated based on battery voltage VB.

Thus, when the temperature of electrolyte in battery 202 decreases, the discharge capacity decreases, and accordingly, battery voltage VB decreases due to the decrease in the discharge capacity. Therefore, the lower the battery voltage VB is measured by control apparatus 201 when ignition switch 205 is turned on, the lower the temperature of engine 101 which is in an atmosphere having the same temperature as that of battery 202.

Hereunder, a flow of the estimating process of water temperature TWS based on battery voltage VB will be described with reference to the flowchart of FIG. 2.

In step S1001, ignition switch 205 is turned on, and in the next step S1002, control apparatus 201 reads battery voltage VB.

Battery voltage VB read by control apparatus 201 in step S1002 is a battery voltage VB obtained before turning on a start switch and in a state in which the battery 202 is not charged by an alternator.

Then, in step S1003, control apparatus 201 estimates water temperature TWS of engine 101 based on battery voltage VB.

A timing of reading battery voltage VB is not limited to a timing at which ignition switch 205 is operated to be in the ON position. For example, in a vehicle provided with a power switch, control apparatus 201 may read battery voltage VB when the ignition becomes in an ON state. Accordingly, control apparatus 201 may read battery voltage VB when power is turned on to control apparatus 201 and engine 101 and when engine 101 is in a stop state.

In battery 202, there is a tendency that the discharge capacity decreases in a condition in which a temperature of electrolyte is low, and accordingly, output voltage VB decreases, and an ambient temperature of battery 202 is substantially the same as that of engine 101.

Therefore, based on battery voltage VB, control apparatus 201 can estimate an ambient temperature at that time, and ultimately, temperature TW of cooling water which represents the temperature of engine 101.

In control apparatus 201, there is set in advance a table or a function representing a correlation between water temperature TWS and battery voltage VB, to convert battery voltage VB to water temperature TWS by using this table or function.

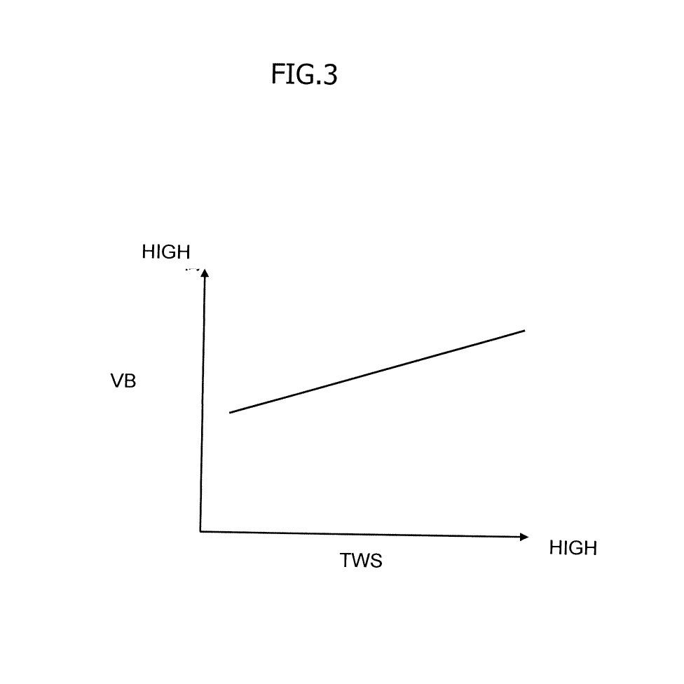

FIG. 3 is an exemplary table for converting battery voltage VB to water temperature TWS.

As illustrated in FIG. 3, characteristics of the table or function are set so that the lower water temperature TWS is estimated for the lower battery voltage VB.

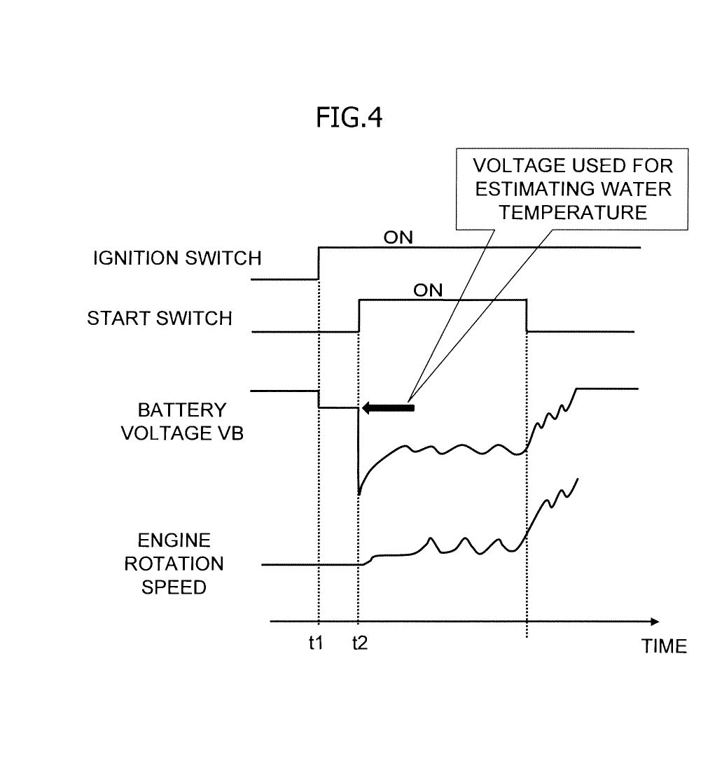

A timing diagram of FIG. 4 illustrates the relationships among battery voltage VB, ignition switch 205, the start switch, and an engine rotation speed, at the time of starting up engine 101.

By turning on ignition switch 205 at time t1, control apparatus 201 is supplied with electric power from battery 202 and electric components, such as a fuel pump of engine 101, and the like, are also supplied with electric power from battery 202, and accordingly, battery voltage VB progresses below a voltage obtained in an OFF state of ignition switch 205.

Then, control apparatus 201 estimates water temperature TWS based on battery voltage VB in a state in which ignition switch is turned on and before the start switch is turned on, that is, battery voltage VB in a state between time t1 and time t2 at which the start switch is turned on.

Thereafter, the start switch is turned on at time t2, so that a starter motor is supplied with electric power from battery 202, and then cranking of engine 101 is started. Then, since electric load expended by the starter motor is large, battery voltage VB decreases more than that before turning on the start switch.

Water temperature TWS estimated based on battery voltage VB may be used to control a fuel injection amount at the time of starting up engine 101 instead of a measured value obtained from water temperature sensor 208 when water temperature sensor 208 has failed, for example.

In a case in which water temperature sensor 208 has failed, by controlling a fuel injection amount at the time of starting up engine 101 based on water temperature TWS estimated based on battery voltage VB, a fuel injection amount almost suitable for an actual water temperature TW can be set. That is, the fuel injection amount can be increased as a temperature of engine 101 decreases, so that an occurrence of failure of startup caused by an over-lean air-fuel ratio can be suppressed.

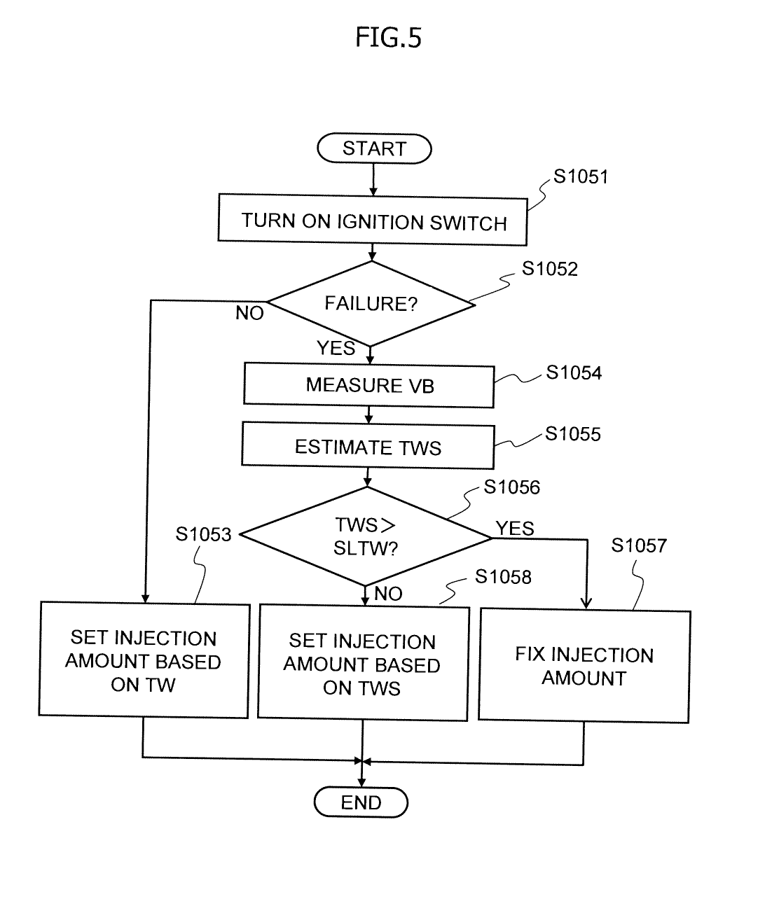

A flowchart of FIG. 5 illustrates one example of a process of controlling the fuel injection amount in a startup state based on water temperature TWS estimated based on battery voltage VB, when water temperature sensor 208 has failed.

In the flowchart of FIG. 5, ignition switch 205 is turned on in step S1051, and in the next step S1052, control apparatus 201 decides whether water temperature sensor 208 has failed or not.

Control apparatus 201 may decide that a failure has occurred, when an output from water temperature sensor 208 is outside a normal range, for example. Furthermore, control apparatus 201 may decide that water temperature sensor 208 is in a failure state when there remains a history indicating that it was diagnosed that a failure occurred in the last operation state of engine 101. As a method for failure diagnosis during an operation of engine 101 may include a method in which determination is made based on a correlation between an operation state of engine 101 and an output of water temperature sensor 208. However, as the method for failure diagnosis of water temperature sensor 208, various well-known methods may be appropriately adopted.

When water temperature sensor 208 is normal, the operation of control apparatus 201 proceeds to step S1053, in which the fuel injection amount in a startup state is controlled based on water temperature TW measured based on an output of water temperature sensor 208.

In contrast, when water temperature sensor 208 has failed and accordingly water temperature TW cannot be measured based on the output of water temperature sensor 208, the operation of control apparatus 201 proceeds to step S1054.

In step S1054, control apparatus 201 reads battery voltage VB.

In the next step S1055, similarly to the step S1003 mentioned above, control apparatus 201 estimates water temperature TINS of engine 101 based on battery voltage VB measured in step S1054.

Then, in step S1056, control apparatus 201 compares water temperature TWS estimates based on battery voltage VB with a threshold SLTW. Then, when water temperature TWS is higher than threshold SLTW, the operation of control apparatus 201 proceeds to step S1057, in which a pre-stored fixed value TPS is set as a fuel injection amount for startup.

On the other hand, when water temperature TWS estimated based on battery voltage VB is equal to or lower than threshold SLTW, the operation of control apparatus 201 proceeds to step S1058, in which a process of changing the fuel injection amount for startup according to water temperature TWS, that is, a process in which the fuel injection amount for startup is increased as water temperature TWS in the startup state of engine 101 decreases, is executed.

That is, when water temperature TWS is equal to threshold SLTW, control apparatus 201 sets fixed value TPS as the fuel injection amount for startup, and as water temperature TWS becomes lower than threshold SLTW, the fuel injection amount for startup is gradually increased from fixed value TPS.

The above-mentioned fixed value TPS is a value set in advance as a fuel injection amount which is suitable in the startup state with a reference water temperature TWK. One example may be TWK=40° C. and SLTW=20° C.

On the other hand, threshold SLTW (SLTW<TWK) is matched as a lower limit of a temperature range in which an air-fuel ratio error caused by using fixed value TPS is greater than an air-fuel ratio error caused by setting fuel injection amount based on water temperature TWS, taking into account an estimation error of water temperature TWS.

That is, in a low temperature region which is below threshold SLTW, an air-fuel ratio error might increase because a difference between a temperature to which fixed value TPS may match and an actual temperature, so that the low temperature region is a temperature region in which an error of air-fuel ratio can be suppressed rather by setting the fuel injection amount based on water temperature TWS even if an estimation error is included in water temperature TWS.

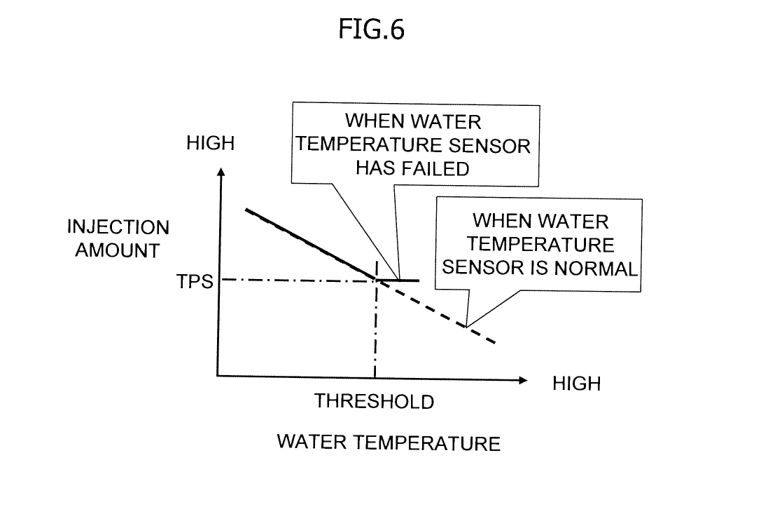

In the above-mentioned controlling process performed by control apparatus 201, as illustrated in FIG. 6, when water temperature sensor 208 has failed, fixed value TPS is set as the fuel injection amount for startup in a temperature region higher than threshold SLTW, while the fuel injection amount is increased from fixed value TPS as water temperature TWS decreases, in a temperature region lower than threshold SLTW, to thereby ensure a high startup performance at low temperature.

Furthermore, when water temperature sensor 208 is normal, the fuel injection amount for startup is set according to water temperature TW measured by water temperature sensor 208 over the entire temperature range including the temperature range higher than threshold SLTW.

According to the above-mentioned control process of the fuel injection amount for startup, when water temperature sensor 208 has failed, the fuel injection amount for startup can be increased as the temperature of engine 101 decreases, based on water temperature TWS estimated based on battery voltage VB. Therefore, internal combustion engine 101 can be started up even in a state in which water temperature sensor 208 has failed and the temperature is low, and an excess amount of fuel can be prevented from being injected.

Furthermore, control apparatus 201 decides whether the air-fuel ratio error caused by the determination error of water temperature TWS obtained based on battery voltage VB is greater than the air-fuel ratio error caused by fixed value TPS or not, to thereby switch between the fuel injection amount for startup based on water temperature TWS and the fixed fuel injection amount for startup. Accordingly, when water temperature sensor 208 has failed, accuracy of controlling air-fuel ratio can be improved comparing to a case in which fixed value TPS is uniformly used.

However, the fuel injection amount for startup obtained based on water temperature TWS may be used over the entire temperature range without using fixed value TPS.

In the estimation of water temperature TWS as illustrated in the flowchart of FIGS. 2 and 5, water temperature TWS at the time of starting up engine 101, that is, a temperature of engine 101 at the time of starting up engine 101 is estimated based on battery voltage VB in a state before engine 101 is started up, which is a state after ignition switch 205 is turned on and until the start switch is turned on.

Here, battery voltage VB in a state after ignition switch 205 is turned on and until the start switch is turned on varies according to whether battery 202 supplies electric power to various electric loads or not, so that the accuracy of estimating water temperature TWS based on battery voltage VB might be decreased.

The electric load to which battery 202 supplies electric power may include electric components, such as an audio instrument, a fan of an air conditioner, a headlight, and the like, and furthermore, a control unit provided separate to control apparatus 201.

Therefore, when water temperature TWS is estimated based on battery voltage VB in the ON state of ignition switch 205, control apparatus 201 executes a process of selecting one or more electric loads to which electric power is supplied from battery 202. That is, by limiting power supply to one or more electric loads except control apparatus 201, variation in battery voltage VB can be suppressed, and accordingly, the accuracy of estimating water temperature TWS based on battery voltage VB can be improved.

For example, control apparatus 201 may suppress variation in battery voltage VB caused by supplying electric power from battery 202 to one or more electric loads besides control apparatus 201: by turning off one or more electric loads except predetermined electric loads, including control apparatus 201; by turning off all of one or more electric loads except control apparatus 201; or by turning off one or more devices, power consumption which is greater than that defined, out of one or more electric loads which are in an ON state except for control apparatus 201.

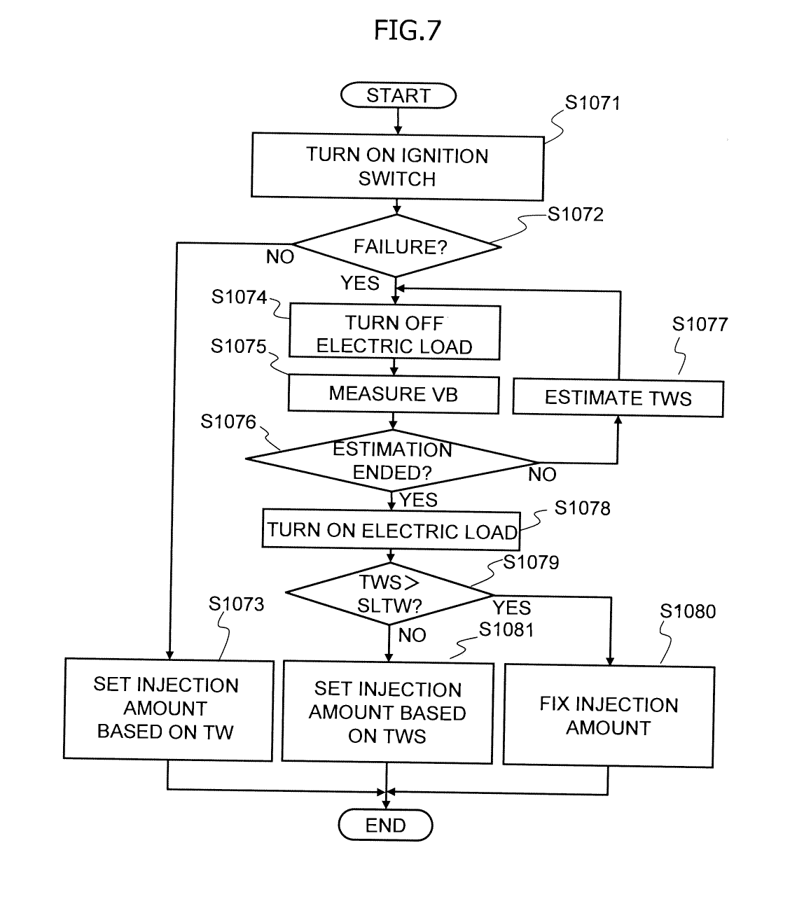

A flowchart of FIG. 7 illustrates one example of a process of limiting one or more electric loads to which electric power is supplied from battery 202.

In the flowchart of FIG. 7, in step S1071, ignition switch 205 is turned on, and in the next step S1072, similarly to step S1052, control apparatus 201 decides whether water temperature sensor 208 has failed or not.

When water temperature sensor 208 is normal, the operation of control apparatus 201 proceeds to step S1073, in which the fuel injection amount in a startup state is controlled based on water temperature TW measured based on an output of water temperature sensor 208.

In contrast, when water temperature sensor 208 has failed, and accordingly, water temperature TW cannot be measured based on the output of water temperature sensor 208, the operation of control apparatus 201 proceeds to step S1074.

In step S1074, control apparatus 201 executes a process of turning off one or more predetermined electric loads.

That is, when battery voltage VB is measured to estimate water temperature TWS, control apparatus 201 selects in advance one or more electric loads to be in the ON state, to turn off one or more electric loads except the one or more selected electric loads. Here, control apparatus 201 may turn off all of one or more electric loads except control apparatus 201. Furthermore, control apparatus 201 may identify in advance one or more electric loads with power consumption exceeding a predetermined amount, to turn off the one or more identified electric loads. The electric load with large power consumption may include an electric pump, an electric four-wheel steering device, and the like.

Thus, in step S1074, control apparatus 201 permits the one or more predetermined electric loads to be supplied with electric power from battery 202, and cuts off power supply to the other one or more electric loads from battery 202.

When control apparatus 201 executes the process of turning off the one or more predetermined electric loads in step S1074, control apparatus 201 measures, in step S1075, battery voltage VB in a state after the turning-off process is executed.

Then, in the next step S1076, control apparatus 201 decides whether a process of estimating water temperature TWS based on battery voltage VB has ended or not. When the process is not ended, the operation proceeds to step S1077, in which the process of estimating water temperature TWS based on battery voltage VB is executed.

After the process of step S1077, the operation of control apparatus 201 returns to step S1074, to continue the limiting state of one or more electric loads to which electric power is supplied.

Then, when control apparatus 201 decides that the process of estimating water temperature TWS based on battery voltage VB is ended in step S1076, the operation proceeds to step S1078, in which the process of limiting the one or more electric loads to which electric power is supplied is cancelled, to allow one or more electric loads, an ON command of which is output, to be supplied with electric power from battery 202.

When control apparatus 201 starts supplying electric power to the one or more electric loads in step S1078, the operation proceeds to step S1079.

Then, in step S1079, control apparatus 201 compares water temperature TWS estimated based on battery voltage VB with threshold SLTW. When water temperature TWS is higher than threshold SLTW, the operation proceeds to step S1080, in which preset fixed value TPS is set as the fuel injection amount for startup.

In contrast, when water temperature TWS estimated based on battery voltage VB is equal to or lower than threshold SLTW, the operation of control apparatus 201 proceeds to step S1081, in which a process of changing the fuel injection amount for startup according to water temperature TWS is executed.

As described above, by suppressing the power consumption in the one or more electric loads except control apparatus 201, the variation in battery voltage VB caused by supplying electric power to the one or more electric loads can be suppressed, and accordingly, the accuracy of estimating water temperature TWS based on battery voltage VB can be improved.

Here, in a case in which the power consumption in the one or more electric loads except control apparatus 201 exceeds a set value, that is, the number of the turned-on electric loads, besides control apparatus 201, is greater than the preset number of electric loads, control apparatus 201 may cancel the determination of water temperature TWS based on battery voltage VB, and then fixed value TPS may be uniformly set as the fuel injection amount for startup.

Furthermore, although the accuracy of estimating water temperature TWS can be improved by executing the process of turning off the one or more electric loads, it should be apparent that the process of turning off the one or more electric loads may be omitted.

Still further, control apparatus 201 may correct battery voltage VB which is used to estimate water temperature TWS, or water temperature TANS estimated based on battery voltage VB, according to the power-supplying condition to the electric loads. In this case, since a decrease in battery voltage VB caused by the electric loads increases as the power supply amount to the electric loads increases, battery voltage VB or water temperature TANS estimated based on battery voltage VB is corrected to thereby obtain higher water temperature TWS.

When engine 101 is started up again after engine 101 is stopped and before cooling water temperature TAN of engine 101 decreases to the ambient temperature, the estimated result of water temperature TWS based on battery voltage VB might be lower than the actual temperature. However, since the estimated result of water temperature TANS based on battery voltage VB becomes equal to or lower than the actual temperature, the probability of failure of startup caused by an over-lean air-fuel ratio because of low temperature can be reduced.

Control apparatus 201 may use water temperature TWS estimated based on battery voltage VB instead of a measured value obtained by water temperature sensor 208 when water temperature sensor 208 has failed, and moreover, control apparatus 201 may decides degradation or a presence of failure of water temperature sensor 208 by comparing water temperature TWS estimated based on battery voltage VB with the measured value TAN obtained from water temperature sensor 208.

Furthermore, in engine 101 in which water temperature sensor 208 is not provided, control apparatus 201 may estimate water temperature TW by setting water temperature TWS estimated based on battery voltage VB as an initial value, to control engine 101 based on the estimated result.

Still further, as a control operation using water temperature TWS estimated based on battery voltage VB, control apparatus 201 may control variable valve timing mechanism 114.

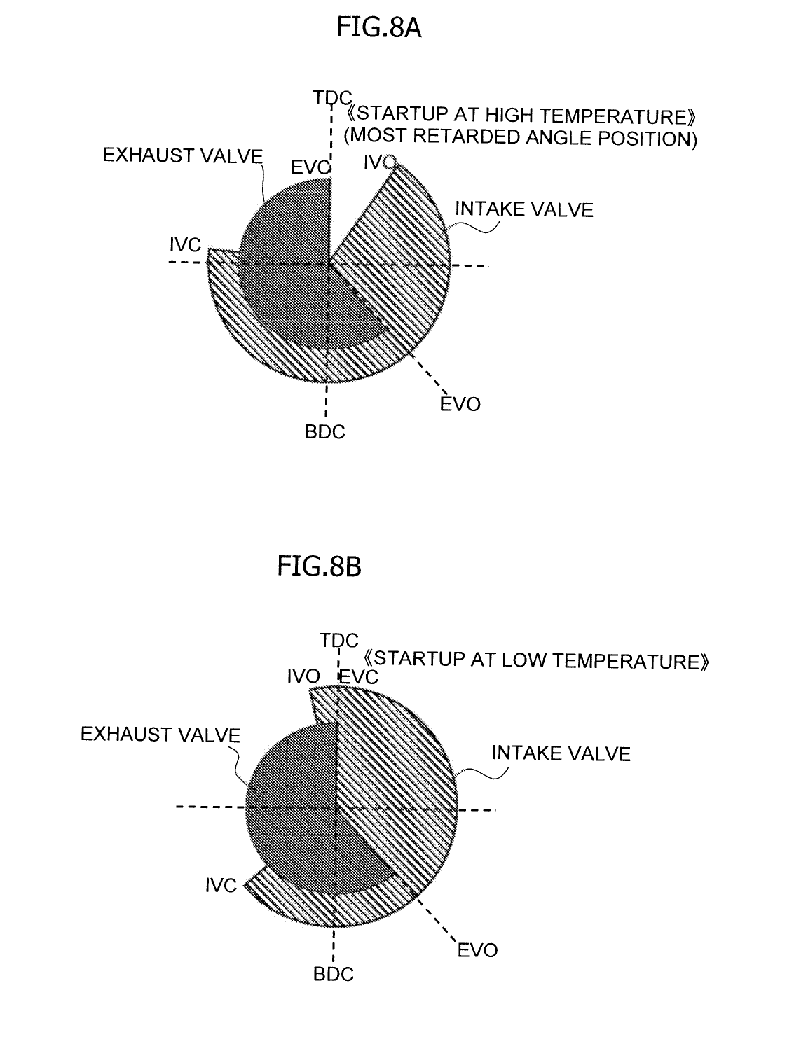

When engine 101 is started up in a condition in which a temperature of engine 101 is high, an occurrence of abnormal combustion, such as pre-ignition, and the like, can be suppressed by decreasing a compression ratio. Therefore, as illustrated in FIG. 8A, control apparatus 201 retards a closing timing IVC of intake valve 105 in a region after bottom dead center BDC.

In the example illustrated in FIG. 8A, closing timing IVC of intake valve 105 is set to from approximately 90 degrees to approximately 110 degrees after bottom dead center BDC, and an opening timing IVO of intake valve 105 is set to from approximately 20 degrees to approximately 40 degrees after top dead center TDC. Furthermore, in the example illustrated in FIG. 8A, an opening timing EVO of exhaust valve 110 is set to from approximately 30 degrees to approximately 50 degrees before bottom dead center BDC, and a closing timing EVO of exhaust valve 110 is set near top dead center TDC.

In contrast, when engine 101 is started up in a condition in which the temperature of engine 101 is low, a startup performance of engine 101 can be improved by increasing a volumetric efficiency ηv of engine 101. Therefore, as illustrated in FIG. 8B, control apparatus 201 advances closing timing IVC of intake valve 105 compared to that in a high temperature condition so that closing timing IVC approaches bottom dead center BDC.

In the example illustrated in FIG. 8B, closing timing IVC of intake valve 105 is set to from approximately 30 degrees to approximately 50 degrees after bottom dead center BDC, and opening timing IVO of intake valve 105 is set to from approximately 20 degrees to approximately 40 degrees after top dead center TDC, and furthermore, opening timing EVO and closing timing EVC of exhaust valve 110 are set substantially the same as illustrated in FIG. 8A.

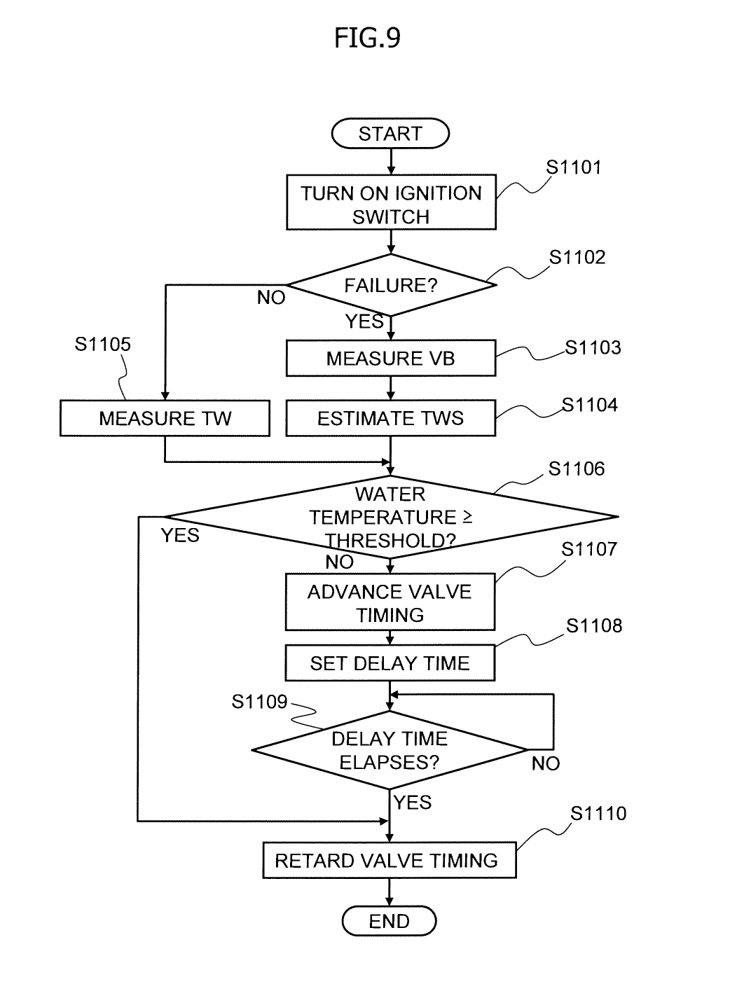

As illustrated in a flowchart of FIG. 9, control apparatus 201 controls variable valve timing mechanism 114 according to water temperature TWS obtained based on battery voltage VB when water temperature sensor 208 has failed.

In the flowchart of FIG. 9, in step S1101, ignition switch 205 is turned on, and in the next step S1102, control apparatus 201 determines whether it is diagnosed that water temperature sensor 208 is abnormal.

In the diagnosis of water temperature sensor 208, control apparatus 201 determines that an abnormality occurs in water temperature sensor 208, when a sensor output is outside a normal range, when a measurement result of water temperature sensor 208 does not reach a temperature after warm-up while an operation of engine 101 continues, or when a sensor output varies in a rate equal to or greater than a set rate. Then, control apparatus 201 sets a flag indicating existence of abnormality, and determines in step S1102 whether water temperature sensor 208 is normal or abnormal by reading the flag.

When water temperature sensor 208 is abnormal, the operation of control apparatus 201 proceeds to step S1103 and thereafter, in which water temperature TWS is estimated based on battery voltage VB, similarly to the process illustrated above in the flowchart of FIG. 2.

In step S1103, control apparatus 201 reads the measured battery voltage VB, and in the next step S1104, control apparatus 201 estimates water temperature TANS based on battery voltage VB.

In contrast, when it is determined that water temperature sensor 208 is normal, the operation proceeds to step S1105, in which water temperature TW is measured based on the output from water temperature sensor 208.

In step S1106, control apparatus 201 compares water temperature TW with a threshold.

The threshold is a value for determining whether it is in a startup state in which a compression ratio may be decreased due to the high temperature of engine 101, or in a startup state in which a volumetric efficiency ηv may be increased due to the low temperature of engine 101.

When control apparatus 201 determines, in step S1106, that water temperature TW is lower than the threshold, the operation proceeds to step S1107.

In step S1107, control apparatus 201 sets a target value of variable valve timing mechanism 114 so that closing timing IVC of intake valve 105 becomes nearer to bottom dead center BDC than that at which the temperature of engine 101 is higher than the threshold. That is, control apparatus 201 set the valve timing illustrated in FIG. 8B as the target value of variable valve timing mechanism 114.

In variable valve timing mechanism 114 according to the present embodiment of the present invention, the most retarded angle position is a default state, and the most retarded angle position is made as a rotational phase for achieving a decreased compression ratio to suppress the occurrence of abnormal combustion, such as pre-ignition, and the like. Thus, the valve timing of intake valve 105 illustrated in FIG. 8A depicts opening characteristics of when an angle of changing of variable valve timing mechanism 114 is the most retarded angle position.

Therefore, when the operation proceeds to step S1107, control apparatus 201 advances the valve timing of intake valve 105 from the most retarded angle position.

Furthermore, in step S1108, control apparatus 201 sets a switching timing from a valve timing which adapts to the low temperature condition of engine 101 to a valve timing which adapts to the high temperature condition of engine 101. Specifically, control apparatus 201 sets a delay time TD which is a period from turning off the start switch and until the valve timing is retarded.

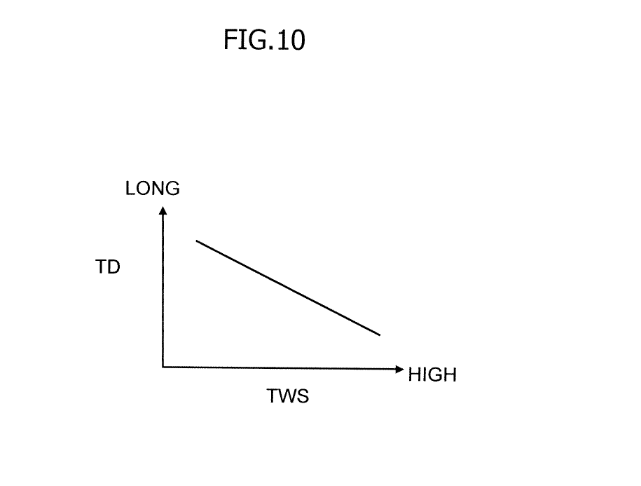

Control apparatus 201 sets delay time TD according to water temperature TW, and sets, as illustrated in FIG. 10, the longer delay time TD for the lower water temperature TW. That is, as water temperature TW decreases, the advanced valve timing is maintained for a longer period even when the start switch is turned off and the startup of engine 101 is completed.

When engine 101 is started up in a condition in which the temperature of engine 101 is low, by maintaining the valve timing to be in the advanced state even after the startup of engine 101 is completed, vaporization of fuel can be promoted by blowback intake air since opening timing IVO of intake valve 105 is advanced. Furthermore, high combustion stability can be ensured due to the high compression ratio, and stability of engine 101 after the completion of startup can be improved.

In step S1109, control apparatus 201 determines whether the above-mentioned delay time TD elapses after turning off of the start switch. Until delay time TD elapses, the advanced valve timing is maintained. Then, in time when delay time TD elapses, the operation of control apparatus 201 proceeds to step S1110, in which the valve timing is retarded to the most retarded angle position.

In contrast, when control apparatus 201 determines that water temperature TWS is higher than the threshold in step S1106, the operation proceeds to step S1110, in which the valve timing is set to maintain the most retarded angle position which is a default state thereof.

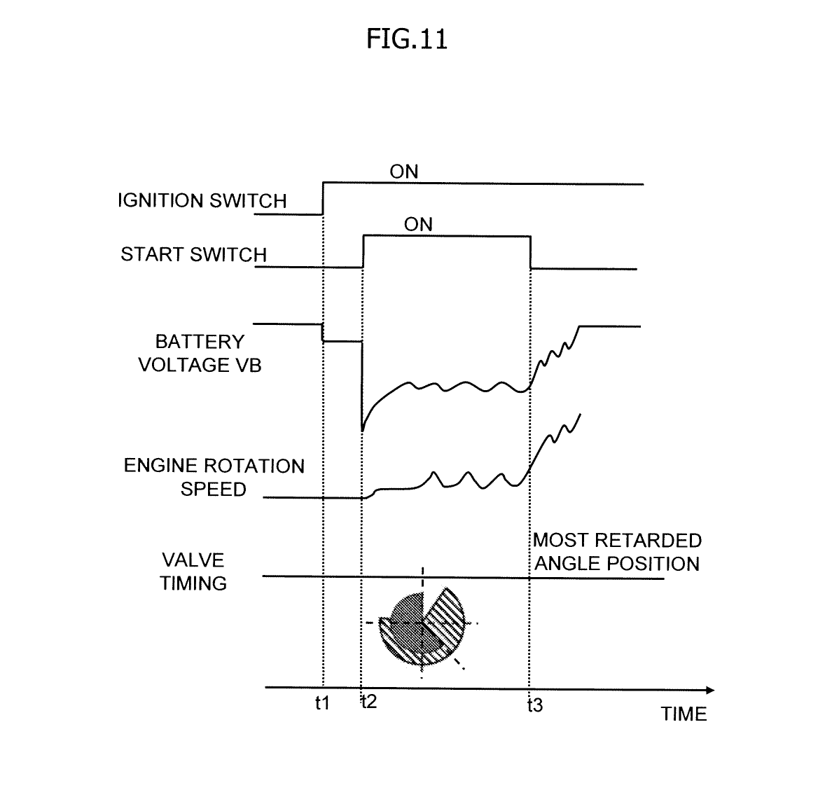

A timing diagram of FIG. 11 illustrates the relationships among battery voltage VB, the valve timing, and the like, at the time of starting up engine 101 in a condition in which the temperature of engine 101 is high.

In a condition in which engine 101 is stopped, when variable valve timing mechanism 114 maintains the default state which is the most retarded position and when ignition switch 205 is switched to the ON state at time t1, control apparatus 201 estimates water temperature TWS according to battery voltage VB.

Here, when water temperature TWS is higher than the threshold, control apparatus 201 maintains the valve timing to be in the most retarded angle position.

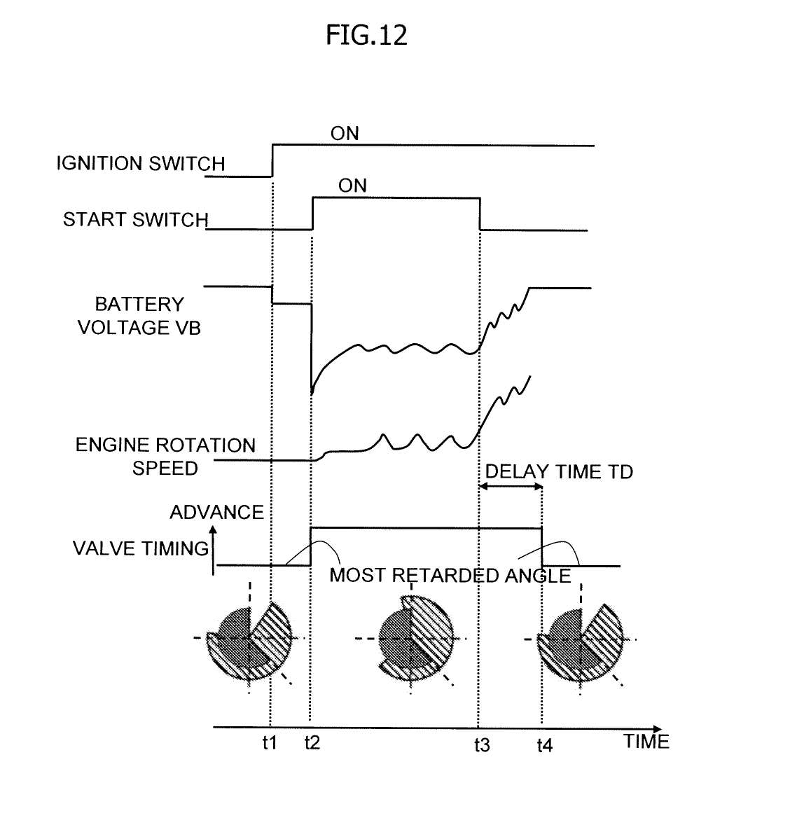

In contrast, a timing diagram of FIG. 12 illustrates the relationships among battery voltage VB, the valve timing, and the like, at the time of starting up engine 101 in a condition in which the temperature of engine 101 is low.

In a condition in which engine 101 is stopped, when variable valve timing mechanism 114 maintains the default state which is the most retarded position and when ignition switch 205 is switched to the ON state at time t1, control apparatus 201 estimates water temperature TWS according to battery voltage VB.

Here, when water temperature TWS is lower than the threshold, control apparatus 201 switches a target valve timing of variable valve timing mechanism 114 to a target for low temperature which is advanced from the default state.

By this process of setting the target valve timing, the valve timing in which the start switch is turned on at time t2 and engine 101 is cranked is maintained to be the valve timing for low temperature which is advanced from the most retarded angle position, and further, after turning off the start switch at time t3, the valve timing for low temperature is maintained during delay time TD.

Then, at time t4 at which delay time TD elapses, the target of variable valve timing mechanism 114 is switched to a valve timing for high temperature which is in the most retarded angle position, so that the valve timing of intake valve 105 is retarded.

When engine 101 is started up in a condition in which the temperature of engine 101 is low, the timing of switching back from the valve timing for low temperature to the valve timing for high temperature which is in the most retarded angle position may be a timing at which the delay time set according to water temperature TWS elapses after turning on the start switch, or may be a timing at which the delay time set according to water temperature TWS elapses after the rotation speed of engine 101 reaches a set speed, and accordingly in both cases, the longer delay time is set for the lower water temperature TWS.

In the above embodiment, as an example of a process of estimating the temperature of engine 101 at the time of starting up engine 101 based on battery voltage VB, the process of estimating water temperature TWS based on battery voltage VB in the ON state of ignition switch 205 before starting up engine 101 has been described. However, water temperature TWS may be estimated based on battery voltage VB after the cranking is started.

When engine 101 is started up in a condition in which the temperature of engine 101 is low and a temperature of a lubricant is also low, friction in engine 101 increases due to high viscosity of the lubricant, and thus, torque of the motor which is required to rotate engine 101 by the starter motor increases. Therefore, voltage VB of battery 202 which is a power source of the starter motor decreases more than in a condition in which the temperature of engine 101 is high.

Therefore, based on battery voltage VB after the cranking is started, a magnitude of the friction of engine 101, and ultimately, the temperature of engine 101 at the time of starting up engine 101, can be estimated.

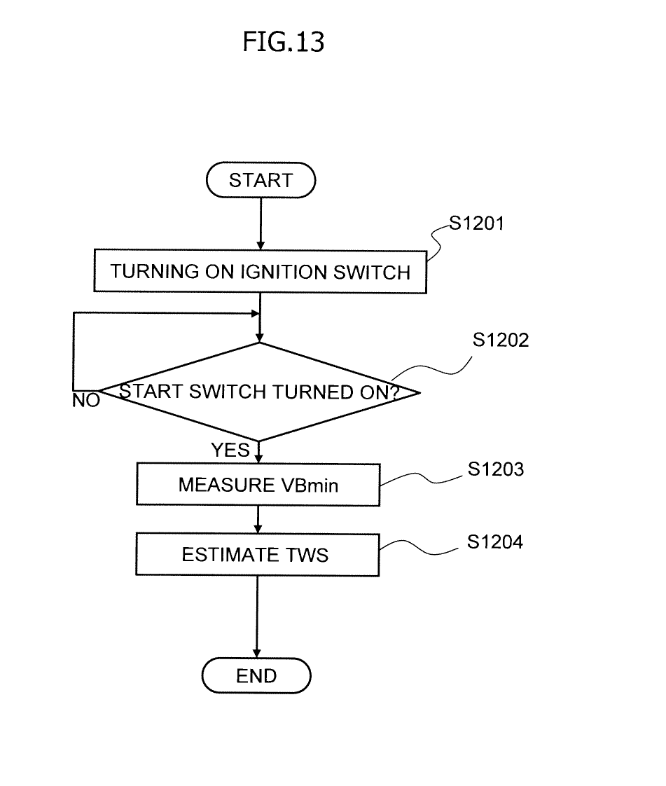

A flowchart of FIG. 13 illustrates one example of a process of estimating water temperature TWS at the time of starting up engine 101 based on battery voltage VB after the cranking is started.

In step S1201, ignition switch 205 is turned on, and in the next step S1202, control apparatus 201 determines whether the start switch is turned on or not, that is, whether the cranking of engine 101 is started or not.

Then, when it is determined that the cranking is started, the operation of control apparatus 201 proceeds to step S1203, in which a minimum value VBmin of voltage VB in the cranking state is measured as battery voltage VB after the cranking is started.

In the cranking of engine 101, since the greatest motor torque is required in time when engine 101 starts moving, battery voltage VB suddenly decreases immediately after the cranking is started, so that it becomes the minimum value VBmin in the cranking state.

Thus, control apparatus 201 may measure a minimum value of battery voltage VB immediately after the cranking is started as minimum value VBmin, or may measure a minimum value among battery voltages VBs periodically measured in a predetermined period after the cranking is started as minimum value VBmin. Here, an end of the predetermined period may be decided based on time, or alternatively, based on the number of occurrences of a rotational angle signal POS output from crank angle sensor 203.

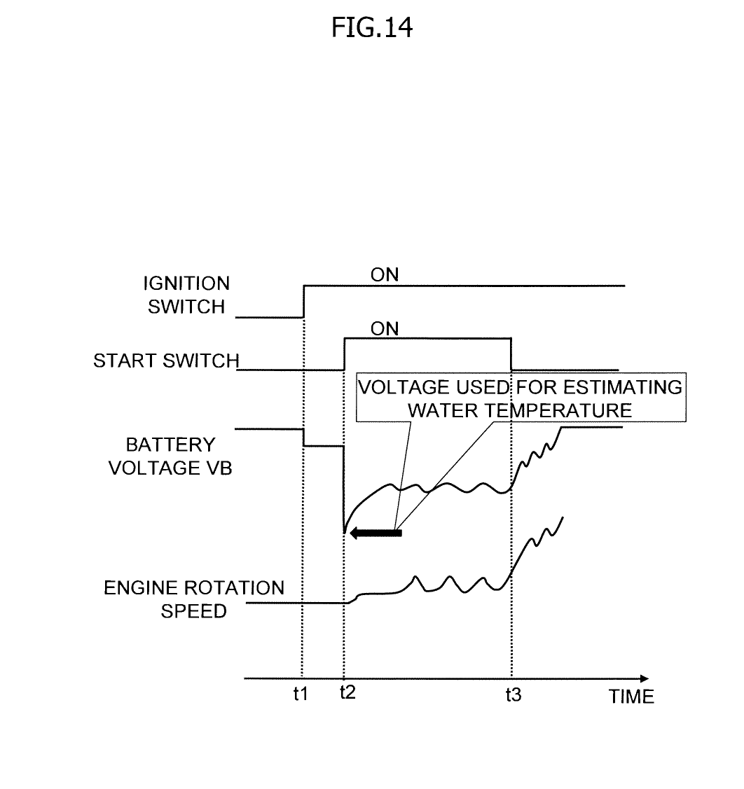

A timing diagram of FIG. 14 illustrates the relationships among battery voltage VB, ignition switch 205, the start switch, and the engine rotation speed at the time of starting up engine 101.

By turning on ignition switch 205 at time t1, control apparatus 201 is supplied with electric power from battery 202 and electric components, such as a fuel pump of engine 101, and the like, are also supplied with electric power from battery 202, and accordingly, battery voltage VB progresses below a voltage obtained in the OFF state of ignition switch 205.

Thereafter, the start switch is turned on at time t2, so that the starter motor is supplied with electric power from battery 202, and then cranking of engine 101 is started. At the time engine 101 starts moving, there is applied a large electric load, and accordingly, battery voltage VB decreases more than that before turning on the start switch. Then, when engine 101 starts rotating, battery voltage VB tends to recover.

Control apparatus 201 estimates water temperature TWS based on battery voltage VB in time when engine 101 starts moving.

When control apparatus 201 measures minimum value VBmin, the operation proceeds to step S1204, in which water temperature TWS is estimated based on minimum value VBmin.

Here, the friction of engine 101 increases as the actual water temperature decreases, and thus, torque required in cranking, or especially, in starting moving, increases, so that battery voltage VB decreases to a greater degree.

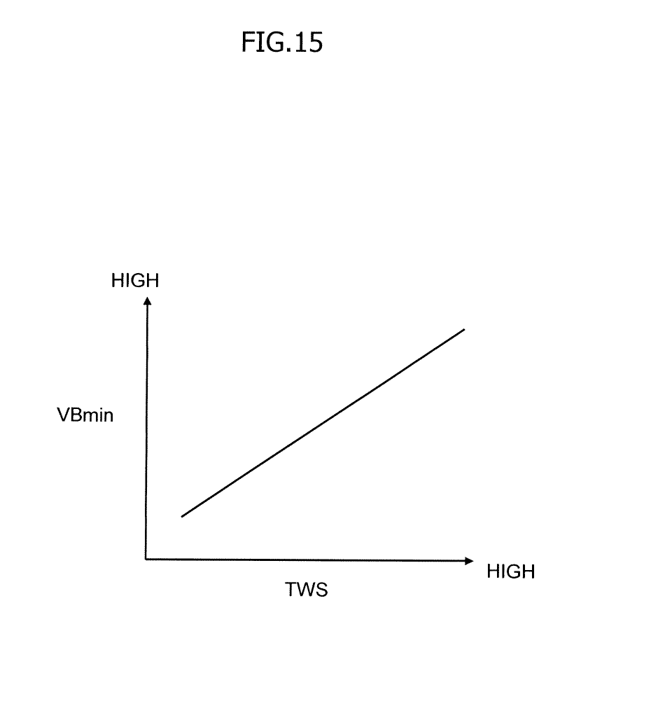

Therefore, in step S1204, control apparatus 201 estimates the lower water temperature TWS for the lower minimum value VB, as illustrated in FIG. 15.

Control apparatus 201 uses water temperature TWS estimated in step S1204 instead of a measured value obtained from water temperature sensor 208 when water temperature sensor 208 has failed, to control the fuel injection amount or variable valve timing mechanism 114.

Furthermore, control apparatus 201 decides a state of degradation or a presence of failure of water temperature sensor 208 by comparing water temperature TWS estimated based on minimum value VBmin with the measured value obtained from water temperature sensor 208. Still further, in engine 101 in which water temperature sensor 208 is not provided, control apparatus 201 can estimate water temperature TW by setting water temperature TWS estimated based on minimum value VBmin as an initial value, to control engine 101 based on the estimated result.

Since minimum value VBmin varies according to the friction of engine 101, when engine 101 is started up in a warm-up state, water temperature TWS which matches the warm-up state can be estimated, and further, when the fuel injection amount in the startup state is set based on water temperature TWS, an excess increase in the fuel injection amount can be suppressed.

Battery voltage VB in the startup state of engine 101 varies according to a state of charge SOC or a state of degradation (state of health) SOH of battery 202. Thus, control apparatus 201 corrects battery voltage VB or water temperature TWS estimated based on battery voltage VB according to at least one of state of charge SOC and state of degradation SOH, to thereby improve the accuracy of estimating water temperature TWS.

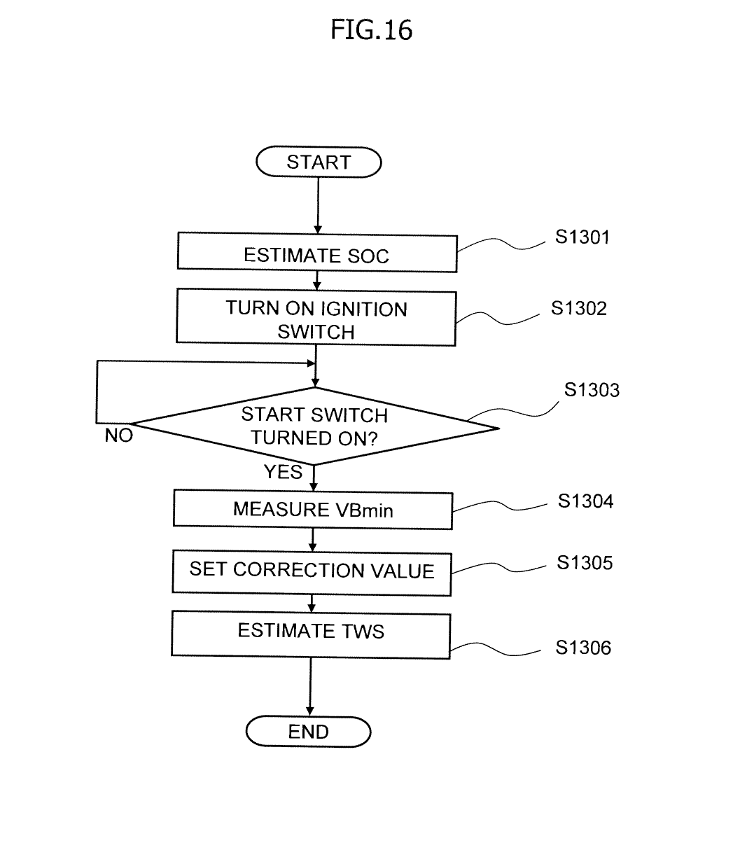

A flowchart of FIG. 16 illustrates one example of a process of estimating water temperature TWS based on battery voltage VB, state of charge SOC, and state of degradation SOH.

In step S1301, in an OFF state of ignition switch 205 and in an open-circuit state of battery 202, control apparatus 201 reads an open-circuit voltage OVB of battery 202 and a temperature TB of battery 202 measured by a battery temperature sensor (not shown).

Then, when ignition switch 205 is turned on in step S1302, control apparatus 201 determines whether the start switch is turned on or not in step S1303. When the start switch is turned on to start cranking, the operation of control apparatus 201 proceeds to step S1304.

In step S1304, control apparatus 201 measures minimum value VBmin of battery voltage VB in the cranking state, similarly to step S1203.

Furthermore, in the next step S1305, control apparatus 201 estimates state of charge SOC based on open-circuit voltage OVB and battery temperature TB which are read in step S1301, to set a first correction value HOS1 for correcting water temperature TWS according to the estimated state of charge SOC.

Here, control apparatus 201 calculates state of charge SOC (%) as follows:

SOC(%)={remaining capacity (Ah)/fully charged capacity (Ah)}/100

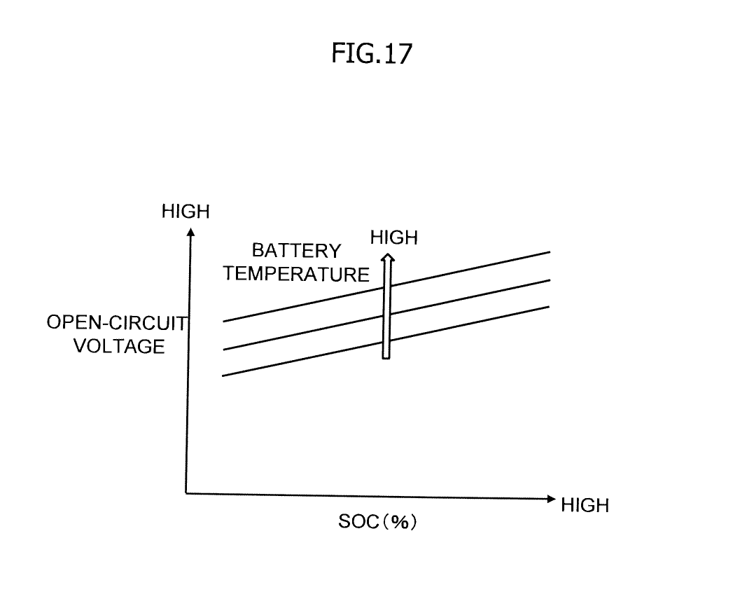

In this case, as illustrated in FIG. 17, when battery temperature TB is constant, open-circuit voltage OVB increases as state of charge SOC increases, and further, under the same open-circuit voltage OVB, state of charge SOC increases as battery temperature TB decreases.

Furthermore, when state of charge SOC decreases, a decrease in battery voltage VB caused by starting cranking increases, and accordingly, minimum value VBmin becomes lower, even at the same actual water temperature.

Thus, control apparatus 201 corrects minimum value VBmin to increase by a greater amount for the lower state of charge SOC, and estimates water temperature TWS based on the corrected minimum value VBmin. Alternatively, control apparatus 201 corrects water temperature TWS estimated based on minimum value VBmin to the higher temperature side for the lower state of charge SOC. Accordingly, even when state of charge SOC varies, water temperature TWS can be estimated with high accuracy.

In the process illustrated in the flowchart of FIG. 16, minimum value VBmin is corrected according to state of charge SOC, and in step S1305, control apparatus 201 sets first correction value HOS1 which corrects minimum value VBmin to increase to a greater amount for the lower state of charge SOC.

State of charge SOC may be estimated by integrating charge-discharge current values, or as a estimating method of state of charge SOC, various known methods may be employed as appropriate.

Furthermore, since minimum value VBmin decreases as an internal resistance increases due to the degradation of battery 202 even at the same actual temperature, control apparatus 201 sets a second correction value HOS2 which corrects minimum value VBmin to increase to a greater amount as the degradation of battery 202 progresses.

Correction value HOS for correcting minimum value VBmin may be set by using state of charge SOC and state of degradation SOH as variables.

In general, degradation of battery 202 progresses in accordance with an increase in total of electric charges which go in and out, and thus, control apparatus 201 may estimate state of degradation SOH of battery 202 based on a parameter corresponding to the total electric charge. Furthermore, since the internal resistance of battery 202 increases due to the degradation, and accordingly, a correlation between voltage and current changes, control apparatus 201 may estimate the internal resistance, that is, state of degradation SOH, based on the open-circuit voltage and voltage drop caused by a connection of a known load resistance.

As described above, control apparatus 201 sets correction value HOS corresponding to state of charge SOC and state of degradation SOH, and then in the next step S1306, corrects minimum value VBmin with correction value HOS corresponding to state of charge SOC and state of degradation SOH, to estimate water temperature TWS based on the corrected minimum value VBmin.

Alternatively, as mentioned above, control apparatus 201 may correct water temperature TWS estimated based on minimum value VBmin, based on state of charge SOC and state of degradation SOH.

Furthermore, control apparatus 201 may execute a process of correcting minimum value VBmin based on any one of state of charge SOC and state of degradation SOH.

Still further, in a system in which no battery temperature sensor is provided, control apparatus 201 may estimate state of charge SOC without using the battery temperature sensor, and may correct battery voltage VB before starting the startup, or water temperature TWS estimated based on the battery voltage VB before starting the startup, according to at least one of state of charge SOC and state of degradation SOH.

The entire contents of Japanese Patent Application No. 2013-022013, filed on Feb. 7, 2013, on which priority is claimed, are incorporated herein by reference.

While only select embodiments have been chosen to illustrate and describe the present invention, it will be apparent to those skilled in the art from this disclosure that various changes and modifications can be made herein without departing from the scope of the invention as defined in the appended claims.

Furthermore, the foregoing description of the embodiment according to the present invention is provided for illustration only, and it is not for the purpose of limiting the invention, the invention as claimed in the appended claims and their equivalents.

What is claimed is:

1. A control apparatus for an internal combustion engine provided in a vehicle in which a battery and the internal combustion engine are mounted, the control apparatus comprising:
a temperature estimating unit that estimates a temperature of the internal combustion engine at the time of starting up the internal combustion engine based on a voltage of the battery.

2. The control apparatus for the internal combustion engine according to claim 1, wherein the temperature estimating unit estimates a temperature of the internal combustion engine based on a voltage of the battery in a state after an ignition switch is turned on before a startup operation of the internal combustion engine.

3. The control apparatus for the internal combustion engine according to claim 1, wherein the temperature estimating unit estimates a temperature of the internal combustion engine based on a voltage of the battery in a state in which an electric load to which electric power of the battery is supplied is turned off.

4. The control apparatus for the internal combustion engine according to claim 1, wherein the temperature estimating unit estimates a temperature of the internal combustion engine based on a voltage of the battery in a state in which the internal combustion engine is cranked.

5. The control apparatus for the internal combustion engine according to claim 1, wherein the temperature estimating unit estimates a temperature of the internal combustion engine based on a decrease in voltage of the battery in a state in which the internal combustion engine is cranked.

6. The control apparatus for the internal combustion engine according to claim 1, wherein the temperature estimating unit estimates a higher temperature of the internal combustion engine for a higher voltage of the battery.

7. The control apparatus for the internal combustion engine according to claim 1, wherein the temperature estimating unit estimates a temperature of the internal combustion engine based on a state of charge of the battery and a voltage of the battery.

8. The control apparatus for the internal combustion engine according to claim 1, wherein the temperature estimating unit estimates a temperature of the internal combustion engine based on a state of degradation of the battery and a voltage of the battery.

9. The control apparatus for the internal combustion engine according to claim 1, wherein the temperature estimating unit estimates a temperature of the internal combustion engine based on a state of supplying electric power to an electric load, a power source of which is the battery, and based on a voltage of the battery.

10. The control apparatus for the internal combustion engine according to claim 1, wherein the internal combustion engine comprises an electrically powered variable valve timing mechanism that makes a valve timing of an engine valve variable,
the control apparatus further comprising a valve timing controlling unit that operates the variable valve timing mechanism according to the temperature of the internal combustion engine estimated by the temperature estimating unit.

11. The control apparatus for the internal combustion engine according to claim 1, further comprising a fuel injection controlling unit that changes a fuel injection amount in a startup state of the internal combustion engine according to the temperature of the internal combustion engine estimated by the temperature estimating unit.

12. A control apparatus for an internal combustion engine provided in a vehicle in which a battery and the internal combustion engine are mounted, the control apparatus comprising:
a temperature estimating means that estimates a temperature of the internal combustion engine at the time of starting up the internal combustion engine.

13. A control method for an internal combustion engine provided in a vehicle in which a battery and the internal combustion engine are mounted, the control method comprising the steps of:
measuring a voltage of the battery at the time of starting up the internal combustion engine;
estimating a temperature of the internal combustion engine based on the voltage of the battery; and
controlling the internal combustion engine based on the temperature of the internal combustion engine.

14. The control method for the internal combustion engine according to claim 13, wherein the step of measuring the voltage of the battery comprises the steps of:
detecting a state of an ignition switch of the internal combustion engine; and
measuring the voltage of the battery in a state after the ignition switch is turned on before a startup operation of the internal combustion engine.

15. The control method for the internal combustion engine according to claim 13, wherein the step of measuring the voltage of the battery comprises the steps of:
turning off an electric load to which electric power of the battery is supplied; and
measuring the voltage of the battery in the OFF state of the electric load.

16. The control method for the internal combustion engine according to claim 13, wherein the step of measuring the voltage of the battery comprises the step of:
detecting a decrease in voltage of the battery in a state in which the internal combustion engine is cranked.

17. The control method for the internal combustion engine according to claim 13, wherein the step of estimating the temperature of the internal combustion engine estimates a higher temperature of the internal combustion engine for a higher voltage of the battery.

18. The control method for the internal combustion engine according to claim 13, further comprising the step of:
estimating a state of charge of the battery,
wherein the step of estimating the temperature of the internal combustion engine comprises the step of:
estimating the temperature of the internal combustion engine based on the state of charge of the battery and the voltage of the battery.

19. The control method for the internal combustion engine according to claim 13, further comprising the step of:
estimating a state of degradation of the battery,
wherein the step of estimating the temperature of the internal combustion engine comprises the step of:
estimating the temperature of the internal combustion engine based on the state of degradation of the battery and the voltage of the battery.

20. The control method for the internal combustion engine according to claim 13, further comprising the step of:
estimating a state of supplying electric power to an electric load, a power source of which is the battery,
wherein the step of estimating the temperature of the internal combustion engine comprises the step of:
estimating the temperature of the internal combustion engine based on the state of supplying the electric power to the electric load and the voltage of the battery.
